(19) United States
(12) Patent Application Publication
(10) Pub. No.: US 2009/0298472 A1
(43) Pub. Date: Dec. 3, 2009

(54) BASE STATION AND MOBILE STATION

(75) Inventor: Hajime NAGANO, Yokohama-shi (JP)

Correspondence Address: MORRISON & FOERSTER LLP, 12531 HIGH BLUFF DRIVE, SUITE 100, SAN DIEGO, CA, 92130-2040, US

(73) Assignee: Kyocera Corporation, Kyoto (JP)

(21) Appl. No.: 12/474,232

(22) Filed: May 28, 2009

(30) Foreign Application Priority Data
May 29, 2008 (JP) JP 2008-141143
May 29, 2008 (JP) JP 2008-141230

(51) Int. Cl. H04L 12/58

(52) U.S. Cl. 455/412.1

(57) ABSTRACT

There is provided a technique for conveying a message in houses of general household or small offices with use of a mobile station (portable terminal device) and a femtocell (a base station and a mobile station serving as message processing apparatuses). A base station (FAP) of a mobile communication system comprises a memory unit (140) storing a message whose destination is a mobile station (AT) of the mobile communication system and a transmission unit (134) transmitting the message to a mobile station (AT) which is the destination of the message stored in the memory unit (140) when the mobile station has been registered or got registered in the base station (FAP).

### CROSS REFERENCE TO RELATED APPLICATION

This application claims priority to and the benefit of Japanese Patent Application No. 2008-141143 and No. 2008-141230 filed on May 29, 2008, the entire contents of which are incorporated herein by reference.

### TECHNICAL FIELD

The present invention relates to a base station and a mobile station.

### BACKGROUND ART

Recently, an apparatus for mobile communication, especially a cellular phone terminal has rapidly come into wide use, and most of areas with a certain population are covered. However, there are some areas where radio waves from a general existing base station (i.e., wide-area base station) cannot reach, which makes the area out of service, and where the radio waves are weak, which brings communication into unstable, such as the interior space of a house or a building, or a place in an unfavorable situation. A small base station having low output power and providing a cell (service area) with a radius of from several meters to several tens of meters has been developed to cover such areas out of service. This small-scale cell itself, or a small base station providing the cell is called a femtocell (see http://e-words.jp/w/E38395E382A7E383A0E38388E382BBE383AB.html). The femtocell is supposed to use a broadband line (general subscriber line) such as ADSL, an optical line (FTTH) or the like spread in each home to connect to a cellular network (cellular phone network).

Since an always-on connection of a broadband line such as an optical line, ADSL or the like has been spread in general household and offices, an infrastructure (i.e., backbone) for connecting the femtocell to a mobile communication terminal is being developed. Moreover, there is also a merit that a telecommunication provider can provide communication service without using a bandwidth of the general existing base station which is supposed to be used by utilizing the femtocell and the broadband line. Therefore, it is conceivable that full-scale development and use of the femtocell will be further expanded.

In general household or an office, there is high demand for people to leave a message (message or memo for sending a word) delivering a subject to their family member or colleague when they are absent. For example, there are cases that a mother wants to make a request such as “Feed the pet”, “Take in the laundry” or the like or deliver a message such as “Your dinner is in a fridge”, “I will be back at 7 in the evening” or the like, to her child or a father who has returned home when she is absent. In addition to subjects in home, moreover, there are also cases that the mother wants to make a reminder such as “Do you have everything?” or “Return home at 20” or check whether or not the above subject in home has been fulfilled by sending a message like “Have you fed the pet?”, to person who will go out after getting home once. Furthermore, there are also cases in an office that a person wants to ask a first person who has come to office to turn on an air conditioner or prepare refreshments for visitors. In addition, there are cases that a person wants to check with another person who will go on business trip what to take and a thing which he has asked the person to do before business trip. That is, there is high demand for messages left when a person who has made a request leaves a place where the request is to be fulfilled, to make sure or remind something.

In order to deliver such messages, it is conceivable that a person conventionally uses a note on which a message is written or, in an office for example, he utilizes an in-company groupware. However, there are possibilities that a person to whom a message is delivered does not notice the note or that a worker cannot notice the message promptly since an active operation is required (e.g., PC activation or the like) when used an in-company groupware. As a technique in which a message is informed (notified, conveyed) to a user without his active operation, there is disclosed a technique in which user's mobile terminal (portable terminal) is used (see JP-A-H07-283872). FIG. 17 is a sequence diagram illustrating a message notification method according to the conventional art. First in the conventional art, a message for a user of a mobile terminal is stored in a network. Then, a request for registration to network is made to the mobile terminal when the mobile terminal to which the stored message is transmitted is turned on or when the location of the mobile terminal has changed from area out of service to service area (within cell of a base station), and then the mobile terminal is notified that the message therefore is stored.

Moreover, there is disclosed a conventional art in which an answering telephone set is used (see JP-A-H06-205099). FIG. 18 is a block diagram of the answering telephone set according to the conventional art. In this answering telephone set, the playback time of a message is preset and stored in a memory with a message. Then, the answering telephone set plays the message at the predetermined playback time.

### SUMMARY OF THE INVENTION

### Technical Problem

However, there is a possibility, when using a note, that a person to whom a message is delivered does not notice it. Moreover, in the conventional art shown in FIG. 18, it is conceivable that a playback time is set to a time when a person (a receiver) to whom a message is sent can be notified of the message, based on a schedule of the receiver. However, the schedule can be often changed and there is thus a possibility that a message is played although the receiver is absent. Moreover, there is also a possibility that a receiver who was once in a place where he could check the message goes out (moves to a place where he cannot check a message) before the message is notified. Furthermore, it is also conceivable that a receiver possibly forget the subject of a message when a certain period of time has elapsed before going out, even if the receiver can be notified of the message requesting a thing to do at an outside location.

In a conventional art shown in FIG. 17, when a first person who returns home first is intended to fulfill the subject of a message in home, for example, a sender of the message sends the message to a person who is supposed to return home first. However, when there occurs a situation in which the intended receiver cannot return home at expected time, it is possible that the subject of the message is fulfilled late or not fulfilled. A sender of a message needs to send the message to every family member so as to avoid such situation, which is inconvenient. In the above conventional art, moreover, when a message is sent from a sender, a destination mobile terminal receives and plays the message at that time in the case that the mobile terminal is within a service area. Therefore, it is not ensured that the receiver (addressee) checks a message again after returning home even when the message is related to a task to be fulfilled after his arrival at home. In most cases, the receiver is more likely to check the message outside his home. As a result, it is possible that the receiver forgets the message contents by the time he returns home and thus the subject in the message is not fulfilled.

That is, there occurs a gap between the time/place at which a message receiver hears or sees the message and the time/place at which the subject of the message is to be checked or fulfilled, which causes receiver's lack of awareness of the message. If it is possible to notify someone of a subject at time/place at which the subject of the message is to be checked or fulfilled, a possibility that the subject is certainly fulfilled increases. However, such techniques have not been developed.

The inventor of the invention has been arrived at a method developing, with use of the femtocell expected to be diffused, a message transmission system having high demand in home or offices so as to solve the above problems. Therefore, an object of the invention is to provide techniques for conveying and informing of messages in houses of general household or small offices with use of a mobile station (portable terminal device) and the femtocell (a base station and a mobile station serving as message processing apparatuses).

### Solution to Problem

In order to solve the above problems, a base station according to the first object of the invention is a base station of a mobile communication system, comprising a memory unit storing a message whose destination is a mobile station of the mobile communication system, (a process unit registering the mobile station based on a request from the mobile station of the mobile communication system,) (a communication unit communicating with the mobile communication system through a communication line) and a transmission unit transmitting the message to a mobile station which is the destination of the message stored in the memory unit when the mobile station has been registered or got registered in the base station.

In a base station according to the second object of the invention, the message includes timing information indicating timing when the mobile station informs of the message (time, a number of times and the like).

In a base station according to the third object of the invention, the message includes timing information indicating timing when the message is to be informed after the mobile station has become unable to detect the base station.

Moreover, a base station according to the fourth object of the invention further comprises a registration unit registering information of a mobile station using the base station (terminal ID, phone number, whether or not allowed to use a base station and the like), and the memory unit stores a message whose destination is a mobile station registered in the registration unit.

Moreover, a base station according to the fifth object of the invention further comprises a reception unit receiving the message from a mobile station registered in the base station, wherein the memory unit stores the message received by the reception unit.

Moreover, a base station according to the sixth object of the invention further comprises an input unit accepting input operation into the base station and a generation unit generating a message whose destination is a mobile station of a mobile communication system based on input to the input unit, wherein the memory unit stores the message generated by the generation unit.

Moreover, a mobile station (portable terminal) according to the seventh object of the invention comprises a reception unit receiving a message whose destination is the mobile station itself stored in a base station from the base station of a mobile communication system, a memory unit storing the message received by the reception unit and a control unit controlling so that the message received from the base station and stored is informed when it becomes impossible to detect the base station from which the message has been received (when it becomes impossible to receive radio waves of the base station from which the message has been received (handover, out of service area, lost or the like)).

In a mobile station according to the eighth object of the invention, the message includes timing information indicating timing (time) when the message is to be informed by the mobile station after the mobile station has become unable to detect the base station, and the control unit controls so that the message is informed based on the timing information.

Moreover, a mobile station according to the ninth object of the invention comprises a reception unit receiving a message whose destination is the mobile station itself stored in a base station from the base station of a mobile communication system, a memory unit storing the message received by the reception unit and a control unit controlling so that the message is informed based on timing information indicating timing when the message is informed (time, number of times and the like) which is included in the message stored in the memory unit.

In a base station according to the tenth object of the invention, (a time management unit managing time is further provided,) the control unit controls so that the message received by the reception unit is informed in the case that timing (time) when the message is received by the reception unit has passed timing (time) when the message is supposed to be informed based on the timing information.

The solution of the invention has been described as above as an apparatus (a base station and a mobile station). However, the invention can be attained as a method substantially corresponding thereto, a program or a storage medium with a program recorded. It will be appreciated that these also fall within the scope of the invention.

The invention makes it possible to provide techniques for conveying and informing of messages in houses of general household or small offices with use of a mobile station (portable terminal device) and the femtocell (a base station and a mobile station serving as message processing apparatuses).

### BRIEF DESCRIPTION OF THE DRAWINGS

The invention will be described in detail with reference to the accompanying drawings, in which:

FIG. 1 is a block diagram of the femtocell according to one embodiment of the invention.

FIG. 2 is a diagram of a table including information of connection-permitted-terminal held by the femtocell.

FIG. 3 is a block diagram of the mobile station according to one embodiment of the invention.

FIG. 4 is a flowchart illustrating one embodiment in which the registration of the mobile station is performed by the femtocell.

FIG. 5 is a schematic view illustrating a process of registering a message to the femtocell by wireless.

FIG. 6 is a flowchart illustrating a process of registering a message to the femtocell by wireless.

FIG. 7 is a schematic view illustrating a process of registering a message to the femtocell by key input.

FIG. 8 is a flowchart illustrating a process of registering a message to the femtocell by key input.

FIG. 9 is a schematic view illustrating a process of transmitting a message to the mobile station by the femtocell FAP.

FIG. 10 is a flowchart illustrating a process of transmitting a message to the mobile station by the femtocell FAP.

FIG. 11 is a diagram illustrating an example of the timing information T-INFO.

FIG. 12 is a flowchart illustrating a message notification process by the mobile station according to one embodiment of the invention.

FIG. 13A is a flowchart illustrating a message notification process by the mobile station according to one embodiment of the invention.

FIG. 13B is a flowchart illustrating a message notification process by the mobile station according to one embodiment of the invention.

FIG. 13C is a flowchart illustrating a message notification process by the mobile station according to one embodiment of the invention.

FIG. 13D is a flowchart illustrating a message notification process by the mobile station according to one embodiment of the invention.

FIG. 14 is a flowchart illustrating a message notification process by the mobile station according to one embodiment of the invention.

FIG. 15 is a diagram illustrating an example of the timing information T-INFO.

FIG. 16 is a flowchart illustrating a message notification process by the mobile terminal according to one embodiment of the invention.

FIG. 17 is a block diagram illustrating a message notification technique according to a conventional art.

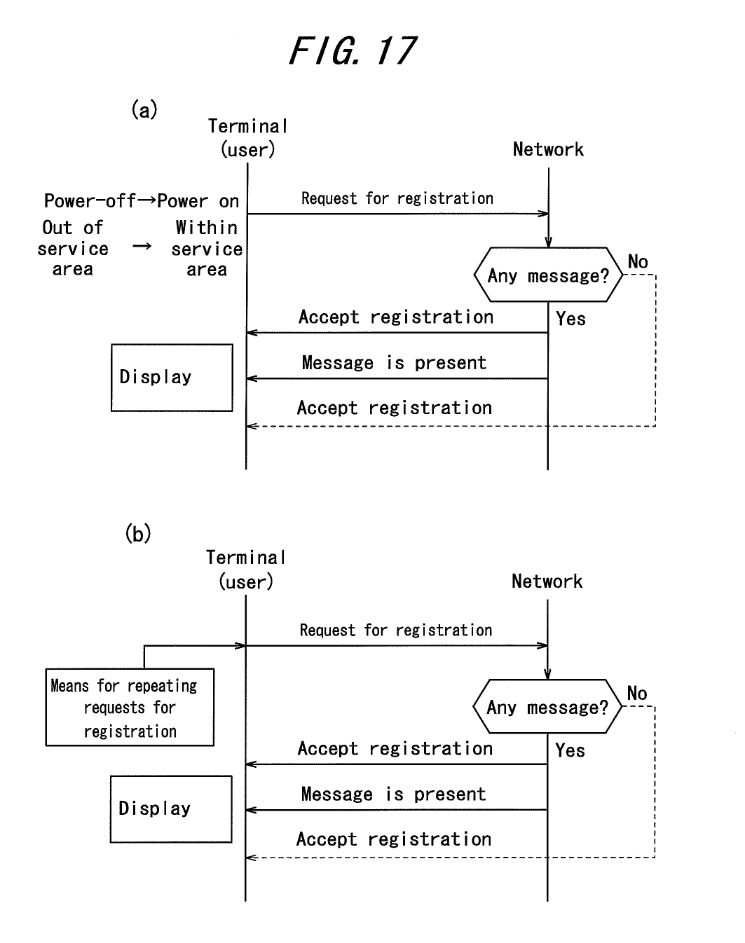

FIG. 18 is a block diagram illustrating an answering telephone set according to a conventional art.

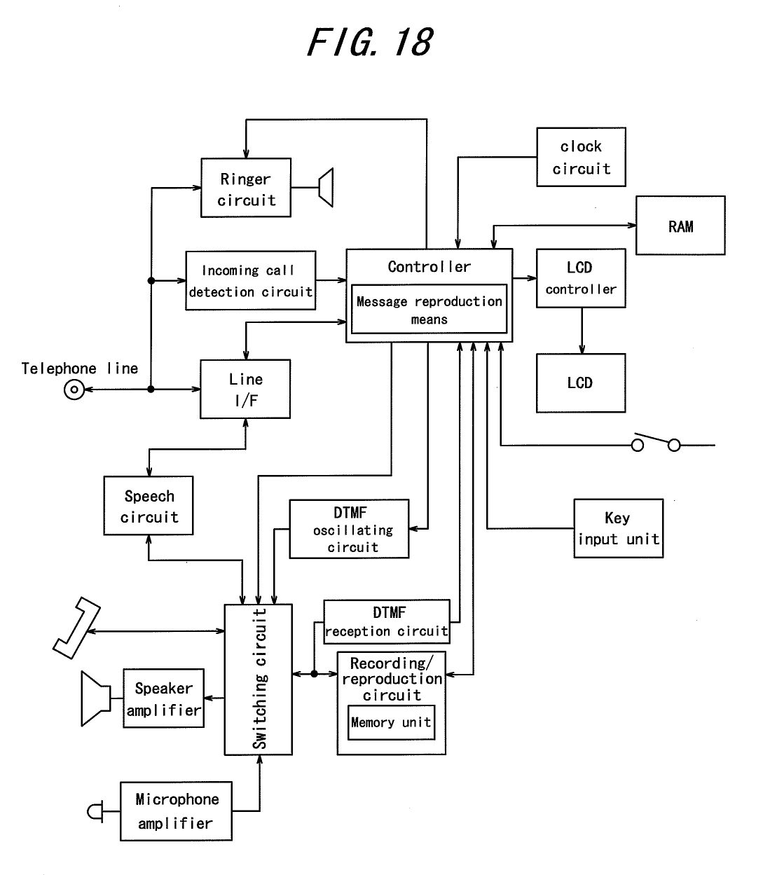

### DESCRIPTION OF EMBODIMENTS

First, a term will be explained. The “femtocell” is a small base station connected to a mobile communication network (cellular network) through a general line (broadband line such as ADSL or the like). In the following description, the invention is described by applying a mobile terminal to a mobile station. However, it will be understood that the invention is not limited thereto. For example, in the invention there can be widely applied portable electronic apparatus such as PDA (personal digital assistant), a portable game device, a portable audio player, a portable video player, a portable electronic dictionary, a portable electronic book viewer or the like as a mobile station, if they can be connected to the femtocell.

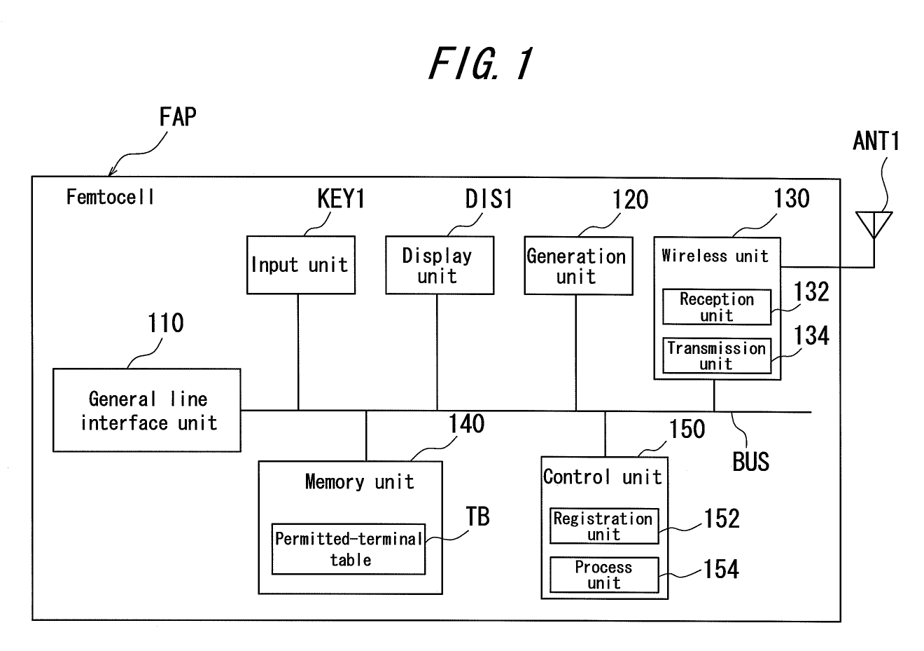

FIG. 1 is a block diagram of the femtocell according to one embodiment of the invention. As shown, the femtocell FAP comprises a general line interface unit 110, a generation unit 120, a wireless unit 130, a memory unit 140, a control unit 150, an input unit (button, touch panel or the like) KEYS, a display unit (liquid crystal monitor, organic EL display, LED display or the like) DIS1, an antenna ANT1, and a system bus BUS. The control unit 150 has a registration unit 152 and a process unit 154. The antenna unit ANT1 transmits and receives radio signals for communicating with a mobile terminal. The wireless unit 130 has a reception unit 132 and a transmission unit 134, and performs wireless communication (which includes transmission/reception of a message and voice call) with a mobile terminal through the antenna ANT1. The input unit KEYS receives inputs of various setting information or the text of a message from a user using the femtocell FAP. The setting information covers information of a mobile terminal (terminal ID, phone number or the like) using the femtocell FAP. The generation unit 120 generates a message based on inputs of a user through the input unit KEY1. The memory unit 140 stores setting information and a message which are input through the input unit KEY1 or received through the antenna ANT1 or the general line interface unit 110. The display unit DIS1 displays the setting information, the message or the like stored in the memory unit 140. The control unit 150 controls the apparatus as a whole. The general line interface unit 110 is connected to a general line (a broadband line such as ADSL or the like) through a router or the like.

The control unit 150 includes a registration unit 152 which registers information of a user using the femtocell FAP, in other words, information of at least one mobile terminal (identification information such as cellular phone number, terminal ID, or the like) using the femtocell FAP, and a process unit 154 which processes a registration (location registration) request by a mobile terminal. The information of the mobile terminal registered by the registration unit 152 is stored in the memory unit 140 as permitted-terminal table TB, for example.

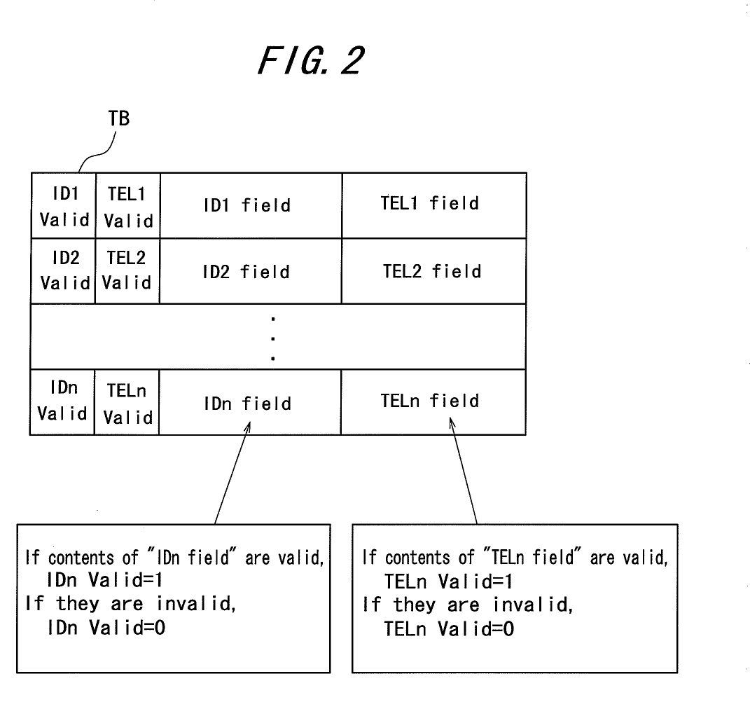

FIG. 2 is a diagram illustrating a table (permitted-terminal table TB) including information of a connection-permitted-terminal (portable terminal using the femtocell FAP) held by the femtocell FAP. As shown in FIG. 2, the permitted-terminal table TB is provided with “IDn Valid”, “TELn Valid”, “IDn field” and “TELn field”. A terminal ID and a mobile phone number belonging solely to a portable terminal possibly using the femtocell FAP are associated with “IDn field” and “TELn field” respectively. “IDn Valid” and “TELn Valid” correspond to “IDn field” and “TELn field” respectively. Thus, if the contents of a field, namely the unique terminal ID and mobile phone number are valid, the corresponding “IDn Valid” and “TELn Valid” become “1”. If they are not valid, on the other hand, the corresponding “IDn Valid” and “TELn Valid” become “0”. When a terminal is registered as one using the femtocell but the message function is not used or the use of the femtocell is temporarily stopped, for example, the contents of Valid is “0” showing being invalid.

A user of the femtocell FAP registers a unique ID of a portable terminal and/or a cellular phone number using the femtocell FAP with using the input unit KEYS of the femtocell FAP, through the general line interface unit 110 or the wireless unit 130, or at the store where he buys the femtocell FAP. Moreover, a user of the femtocell FAP registers a unique ID of a portable terminal and/or a cellular phone number allowed to be connected with the femtocell FAP. The registered information of the portable terminal is stored in a corresponding field in the permitted-terminal table TB. A person who enters and goes out of a building in which the femtocell is established (family member, house keeper, or the like) may be included as a user of the portable terminal. The portable terminal whose information as above is registered can perform wireless communication through the femtocell FAP after its location is registered in the femtocell FAP.

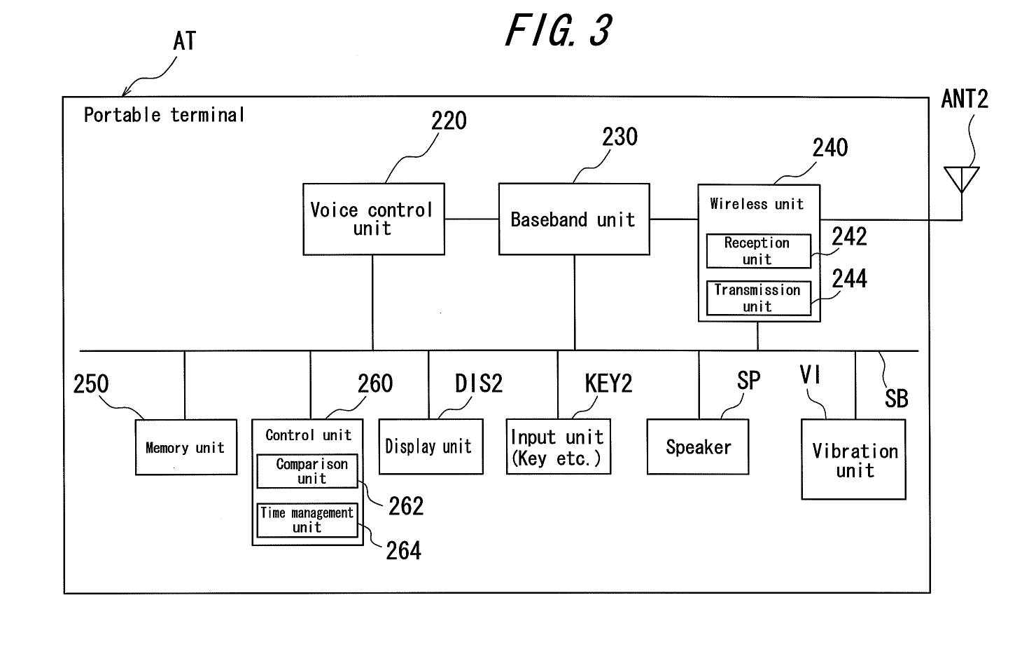

FIG. 3 is a block diagram of the portable terminal according to one embodiment of the invention. As shown in the drawing, the portable terminal (access terminal) AT comprises a voice control unit 220, a baseband unit 230, a wireless unit 240, a memory unit 250, a control unit (for example, CPU or the like) 260 for controlling the terminal as a whole, a speaker SP, a display unit DIS2, an input unit (key, button or the like) KEY2, an antenna ANT2, a vibration unit VI and a system bus SB. The wireless unit 240 has an reception unit 242 and a transmission unit 244, and transmits/receives a message to/from the femtocell FAP by performing wireless communication with the femtocell FAP through the antenna ANT2. The control unit 260 controls generation of a message to be transmitted to the femtocell FAP and exchange of a message with the femtocell FAP. Moreover, the control unit 260 also controls a registration request to the femtocell FAP. The voice control unit 220 controls a voice call of the portable terminal AT. The baseband unit 230 processes a baseband signal. The memory unit 250 stores a message received from the femtocell FAP. The display unit DIS2 displays the message received from the femtocell FAP. On the other hand, the received message may be informed by sounds through the speaker SP. The input unit KEY2 accepts input operation for generating a message by a user. The control unit 260 performs control for informing the user of the received message. A comparison unit 262 included in the control unit 260 compares timing information included the received message with a current time based on the time indicated by a time management unit 264, and notifies the control unit 260 of the comparing result. The vibration unit VI includes, for example, a small-sized motor or the like and vibrates the portable terminal AT.

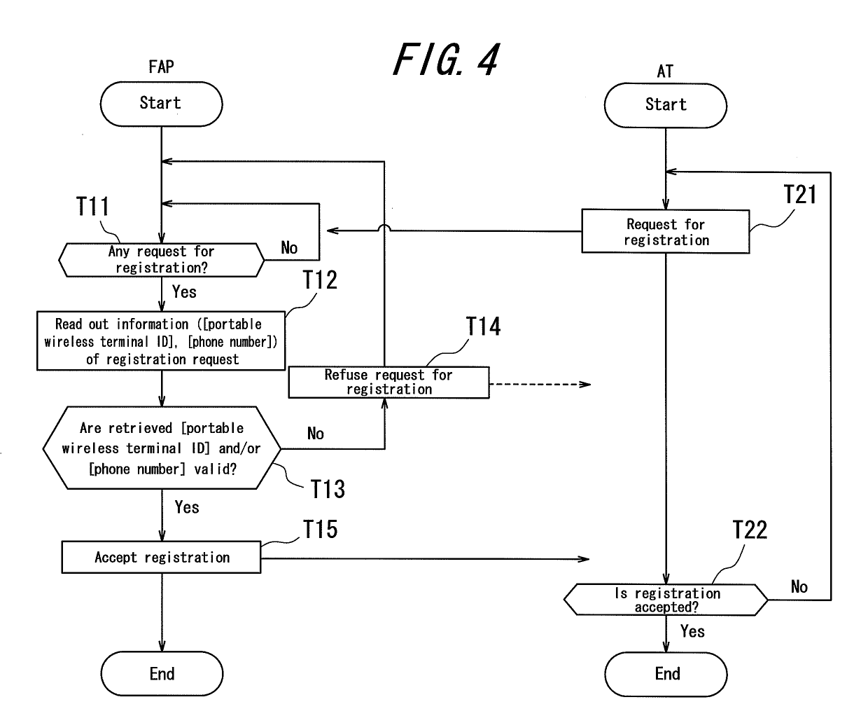

There will be described the registration of the portable terminal AT to the femtocell FAP. FIG. 4 is a flowchart illustrating one embodiment in case that the femtocell FAP registers the portable terminal AT. First, the portable terminal AT makes a request for registration to the femtocell FAP (Step T21). That is, the information of a terminal ID and a cellular phone number belonging solely to the portable terminal is transmitted to the femtocell FAP. The femtocell FAP determines whether or not there is a request for registration from a portable terminal (Step T11). When receiving a request for registration from a portable terminal, the femtocell FAP reads out the terminal ID and/or the cellular phone number of the portable terminal requesting registration (Step T12). Next, the femtocell FAP determines whether or not the retrieved terminal ID and/or cellular phone number are valid, namely whether or not the retrieved terminal ID and/or cellular phone number are registered in the permitted-terminal table TB as valid ones (Step T13). When a portable terminal is not valid, information conveying the refusal of a request for registration is transmitted to the portable terminal AT (Step T14). When a portable terminal is valid, a request for registration is accepted and the information conveying such acceptance is transmitted to the portable terminal AT (Step T15). The portable terminal AT determines whether or not the registration is accepted (Step T22). When the request is accepted, the registration process is terminated. When the registration is refused, the process returns to Step T21 and a request for registration is made again. It is noted that the process can be terminated when the request for registration is refused a given number of times.

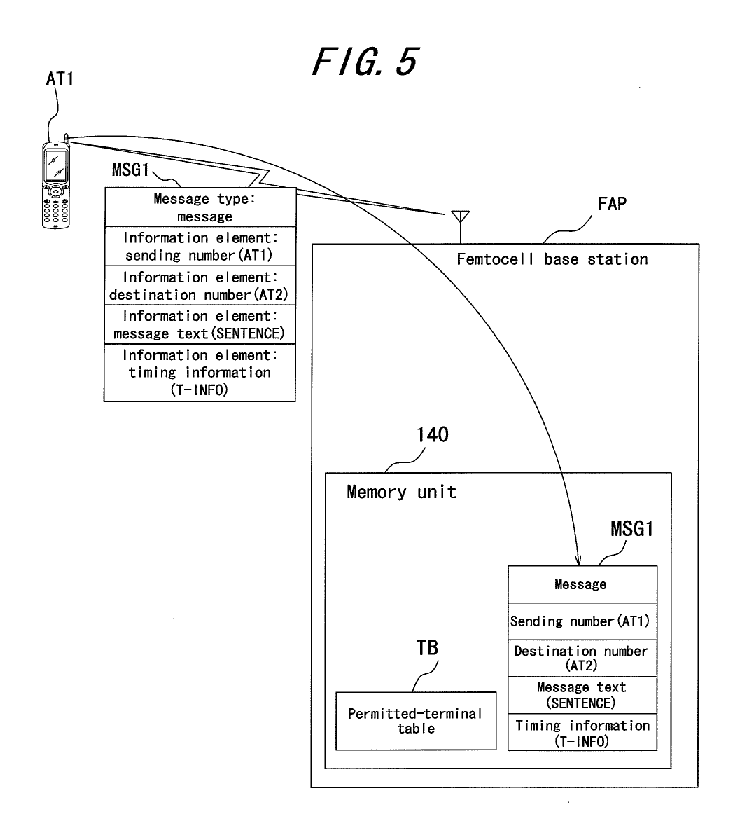

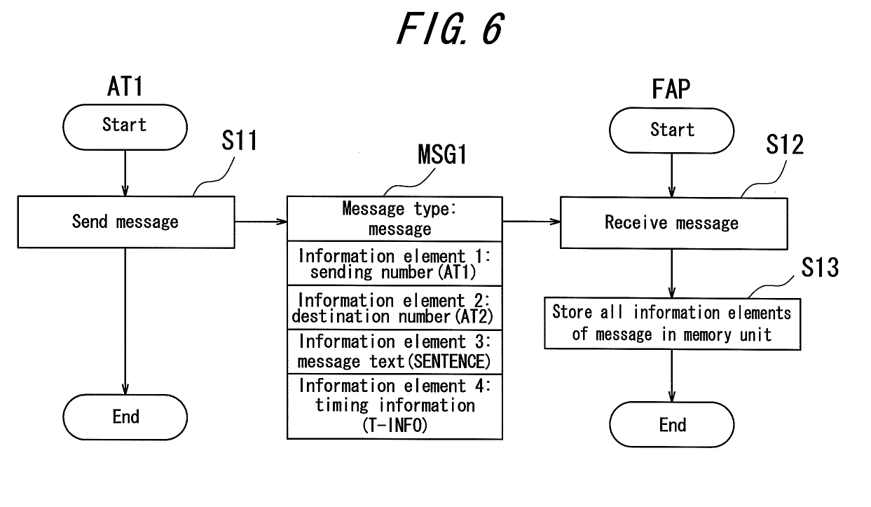

Next, a process for a user (sender) who wants to send a message to register a message at the femtocell FAP will be described by referring to drawings. In following description, the portable terminal AT1 is a portable terminal (sending terminal) of a sender of a message and the portable terminal AT2 is a portable terminal (destination terminal) of an addressee of a message. FIGS. 5 to 8 are schematic diagrams illustrating processes of registering a message to the femtocell FAP by a sender. The registration method of a message may be divided into a case that a sender forms a message using his portable terminal AT1 and sends the message to the femtocell FAP by wireless and a case that a sender inputs a message to the femtocell FAP directly by using the input unit KEY1 of the femtocell FAP. First, the former case will be described using the schematic diagram of FIG. 5 and the flowchart of FIG. 6. A message sender (not shown) forms a message MSG1 using his portable terminal AT1, and sends the message MSG1 to the femtocell FAP (Step S1). The message MSG1 includes at least a “message type” and “information element” as shown in FIG. 5 and FIG. 6. The “message type” is information indicating a kind of the message, and indicates that the message is either a message for sending a word, a message of short message service, an email message or the like. The “information element” includes a sending number (sender information), a destination number (addressee information), message text SENTENCE, timing information T-INFO and the like. The sending number and the destination number are a terminal ID, a phone number or the like. The timing information T-INFO is information indicating timing for informing of a message in a terminal that receives the message (an elapsed time after the destination terminal cannot receive radio waves from the femtocell FAP, time at which the terminal is to be informed of the message, absolute time, relative time, the number of times of informing and the like). The timing information T-INFO may be optional as described later in detail. The femtocell FAP receives a message MSG1 transmitted from the portable terminal AT1 (Step S12), and stores the message in the memory unit 140 (Step S13). On the other hand, a sender may send a formed message to the femtocell FAP through the general line interface unit 110.

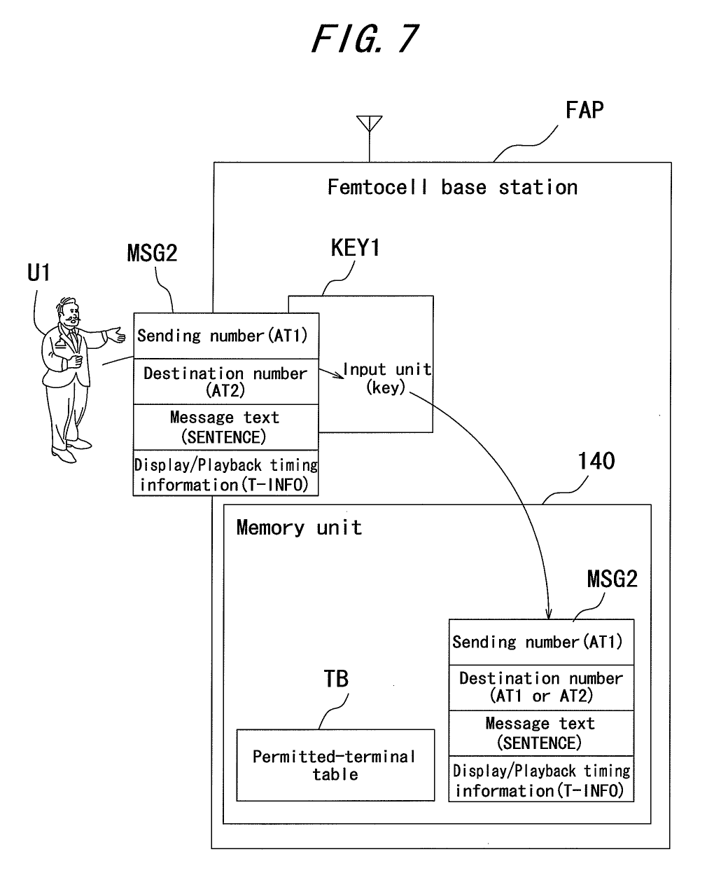

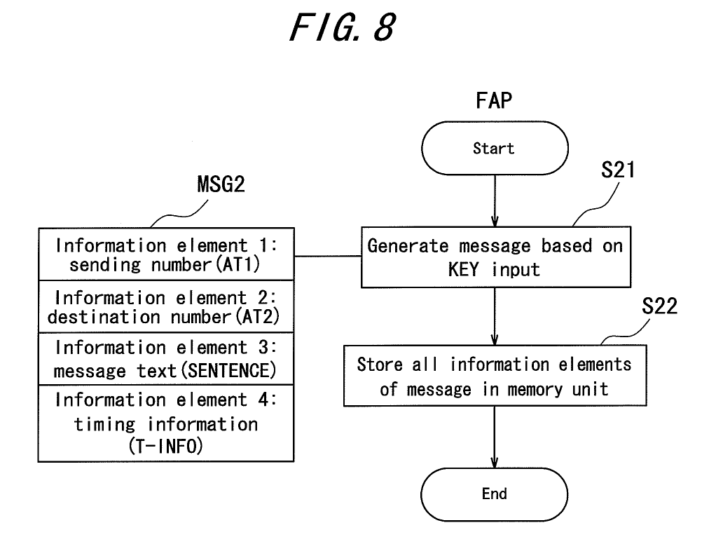

Next, the case in which a sender inputs a message to the femtocell FAP directly using the input unit KEY1 of the femtocell FAP will be described by referring to the schematic diagram of FIG. 7 and the flowchart of FIG. 8. A sender U1 inputs a message MSG2 using the input unit KEY1 of the femtocell FAP, and the femtocell FAP generates the message MSG2 (Step S21). The message MSG2 includes a “sending number”, a “destination number”, “message text” and “timing information”. And, the message may include “message type: a message for sending a word”. The timing information T-INFO may be optional as described later in detail. The femtocell FAP which generates the message MSG2 stores the generated message MSG2 in the memory unit 140 (Step S22). Sender information such as text information indicating a name of a user who input the message or the like may be included as an item for forming the message MSG2 instead of the “sending number”.

It is also possible, in both cases, that a terminal which is allowed to be registered by the femtocell and which is registered in the femtocell FAP first can be specified instead of destination number. In this case, the femtocell FAP transmits a message to a terminal which is registered first in the femtocell FAP. It is noted that when there is a terminal which has been already registered the message is transmitted thereto. When there is a plurality of registered terminals, the message is transmitted to all of them.

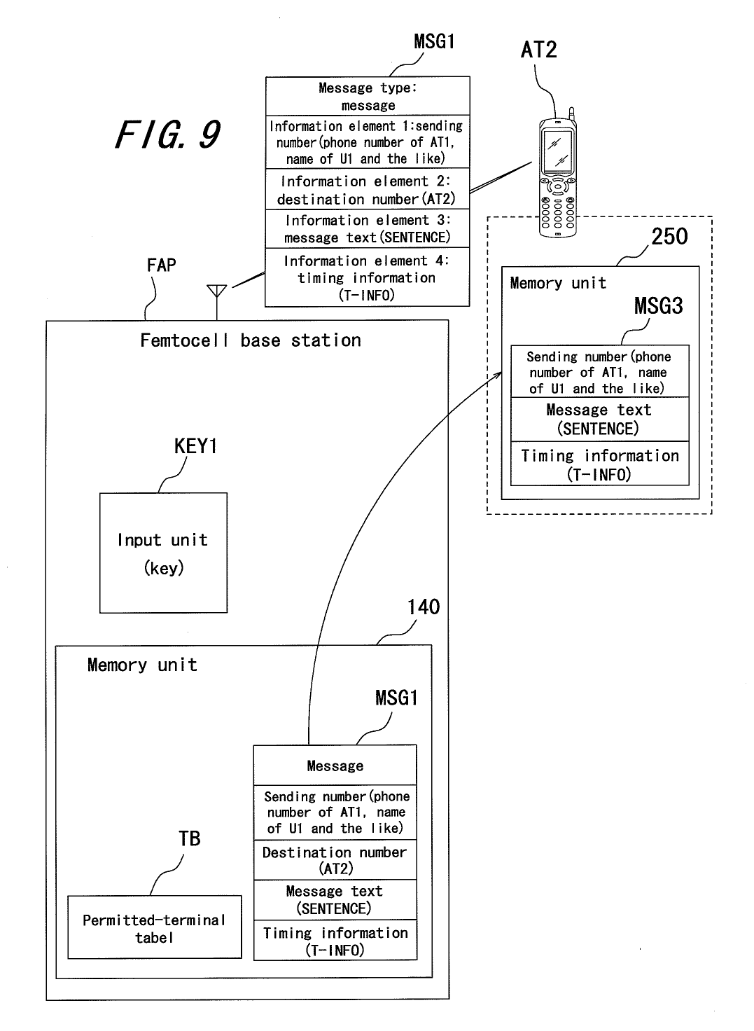

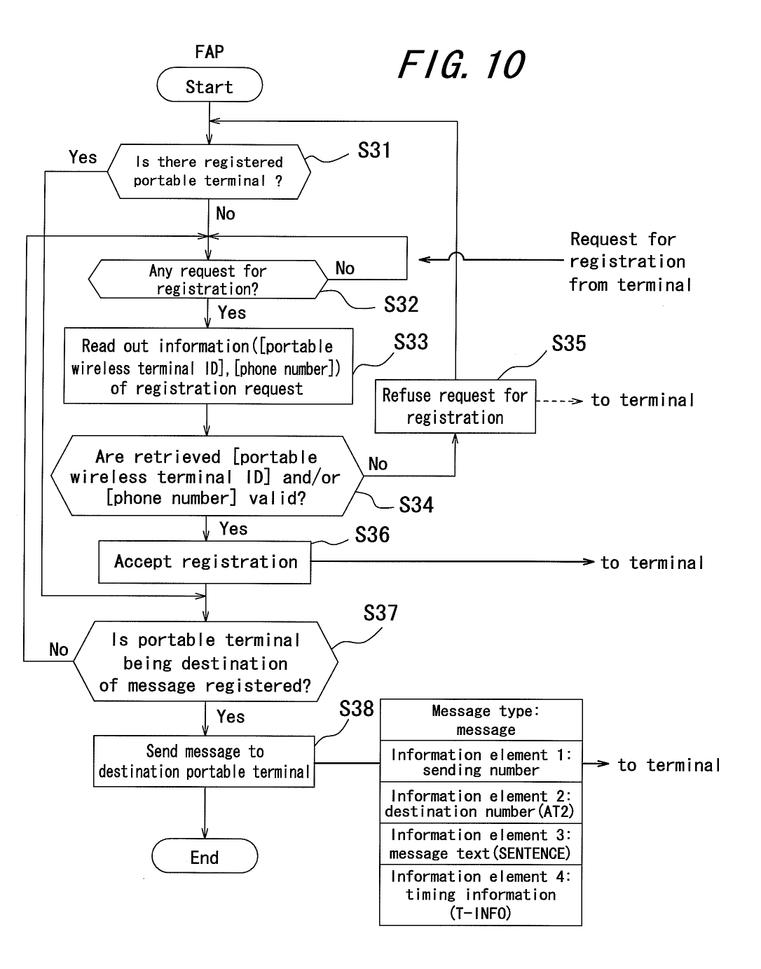

Next, a process for the femtocell FAP to transmit the message MSG1 (or MSG2) stored in the femtocell FAP to the portable terminal AT2 to which the message is to be sent will be described. FIG. 9 and FIG. 10 are a schematic diagram and a flowchart illustrating a process of transmitting the message to the portable terminal AT2 by the femtocell FAP.

When receiving a message or generating a message by the processes described by referring to FIGS. 5 to 8, the femtocell FAP starts a process of transmitting a message to a portable terminal. First, the control unit 150 determines whether or not there is a portable terminal for which the process unit 154 performs a registration process (whether or not information of a registered terminal is stored in the memory unit 140) (Step S31). When it is determined that there is a registered terminal, the control unit 150 determines whether or not a portable terminal which is a destination of a message stored in the memory unit 140 is registered (Step S37). When it is determined that there is a message whose destination is a registered portable terminal, the femtocell FAP transmits the message MSG1 to the portable terminal AT2 of the destination as shown in FIG. 9 (Step S38). As shown in FIG. 9, when the message is transmitted by the femtocell FAP, the portable terminal AT2 of the destination stores a message MSG3 including a “sending number” (sender of the message), “message text” and “timing information” in the memory unit 250. When it is determined that there is no registered portable terminal at Step S31, or that a portable terminal which is the destination of the message is not registered at Step S37, the process proceeds to Step S32, and the process unit 154 determines whether or not there is a registration request from the portable terminal. When it is determined that there is a registration request from a portable terminal at Step S32, the registration request is processed at Steps S33 to S36. This process is same as Steps T12 to T15 in the above FIG. 4, and the description is thus omitted.

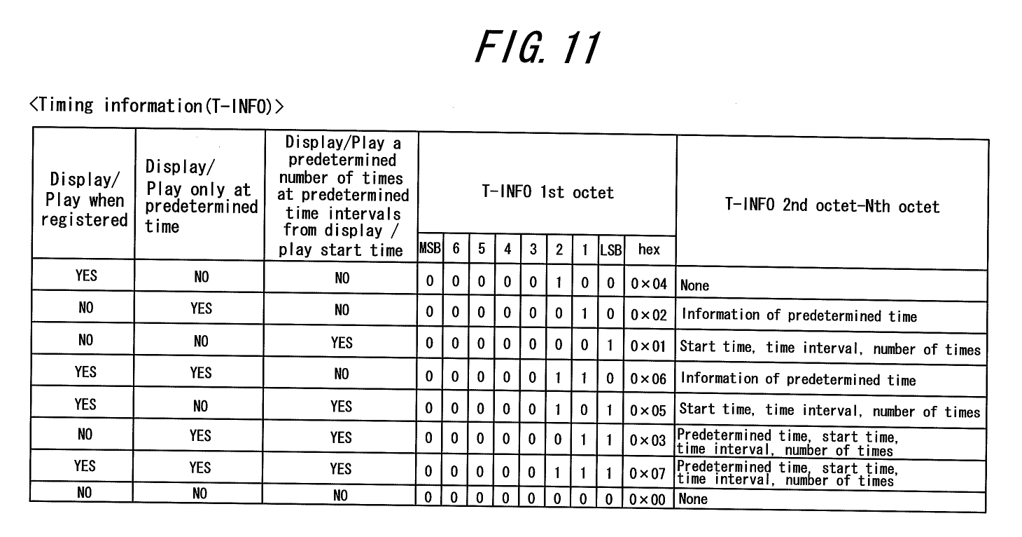

First, there will be described an embodiment in which a user having a mobile station (mobile terminal) can be informed of a message at adequate time and place, which dramatically decreases a possibility that the subject of the message is not fulfilled. Timing information T-INFO is included in the message MSG1 (or MSG2) transmitted to the portable terminal AT from the femtocell FAP. The timing information T-INFO will be described here. FIG. 11 shows an example of the timing information T-INFO. As shown, the timing information T-INFO includes information indicating when the portable terminal AT informs (plays/displays) a message which it has received. In the example of the drawing, the timing information T-INFO includes in the first octet information indicating one of three patterns; “inform (display/play) when registered”, “inform (display/play) only at a predetermined time” and “inform (display/play) a predetermined number of times at predetermined time intervals from an informing (display/play) start time” or a combination thereof. In addition, the second octet includes information required to conduct the process ordered in the first octet. For example, the first octet shown in the second line of the timing information T-INFO indicates “not inform (display/play) when registered (NO)” and “inform (display/play) only at a predetermined time” and the second octet includes information about the “predetermined time”.

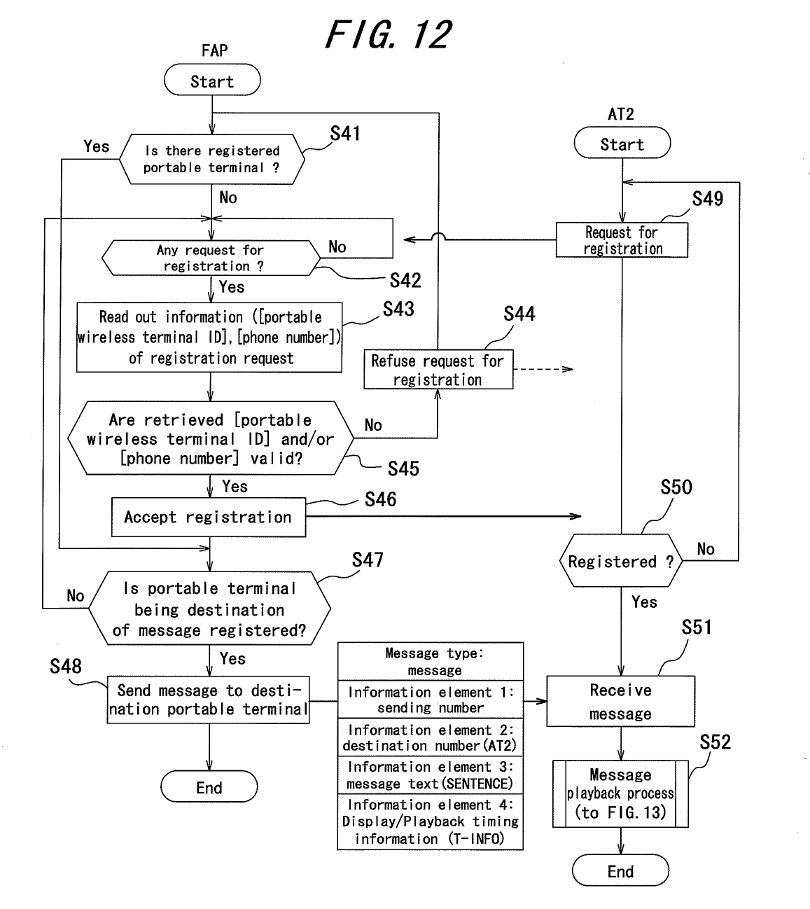

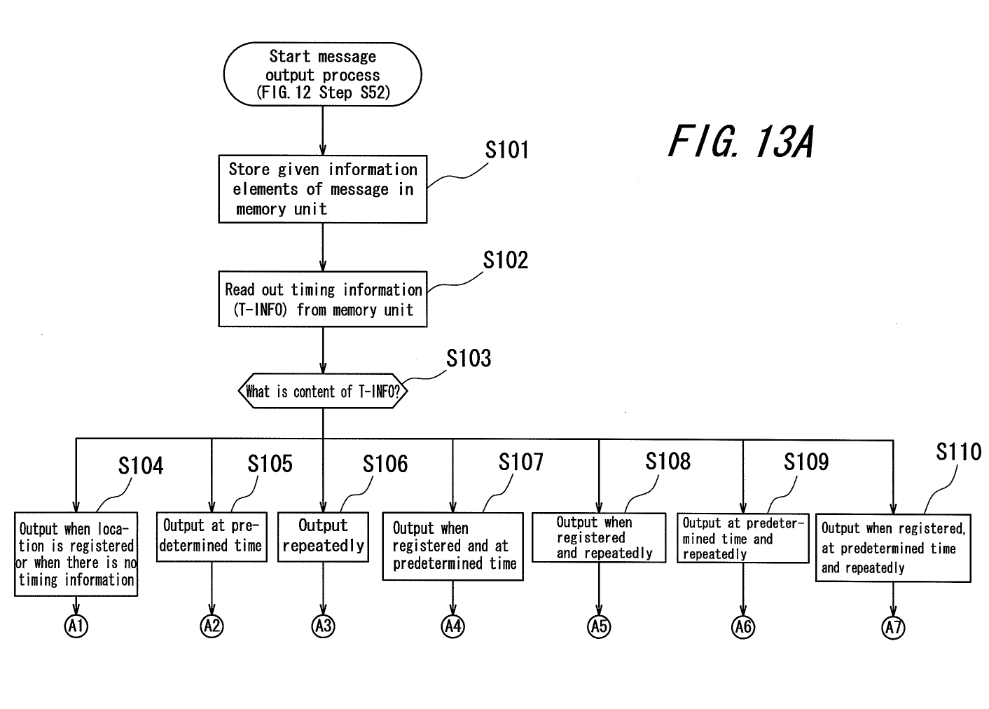

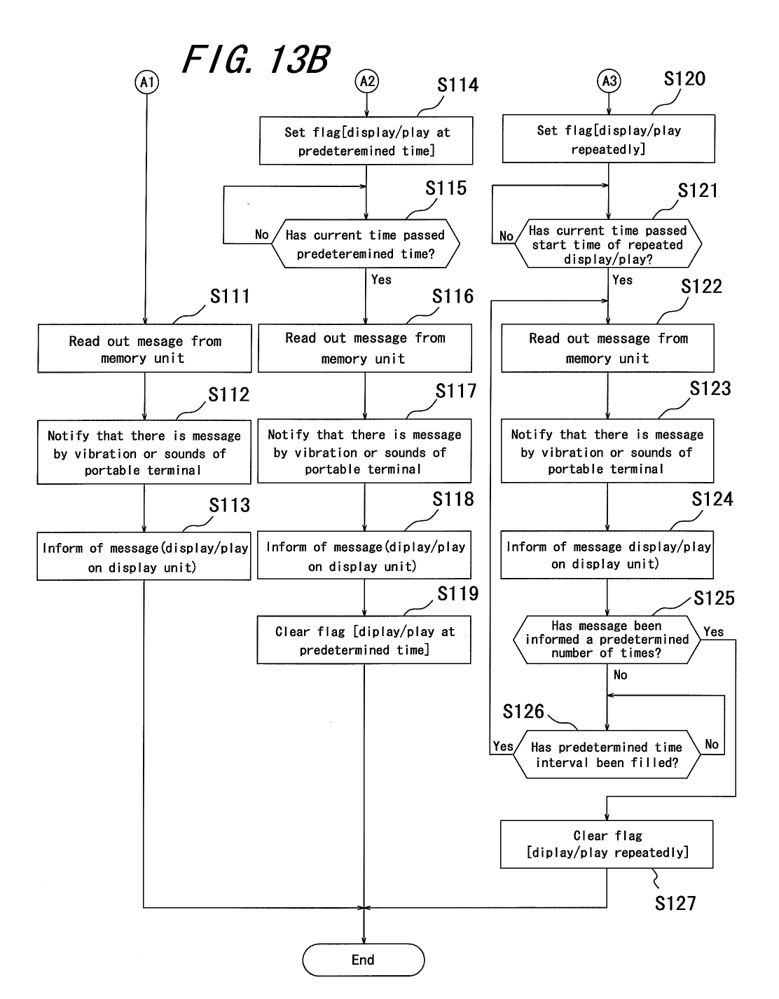

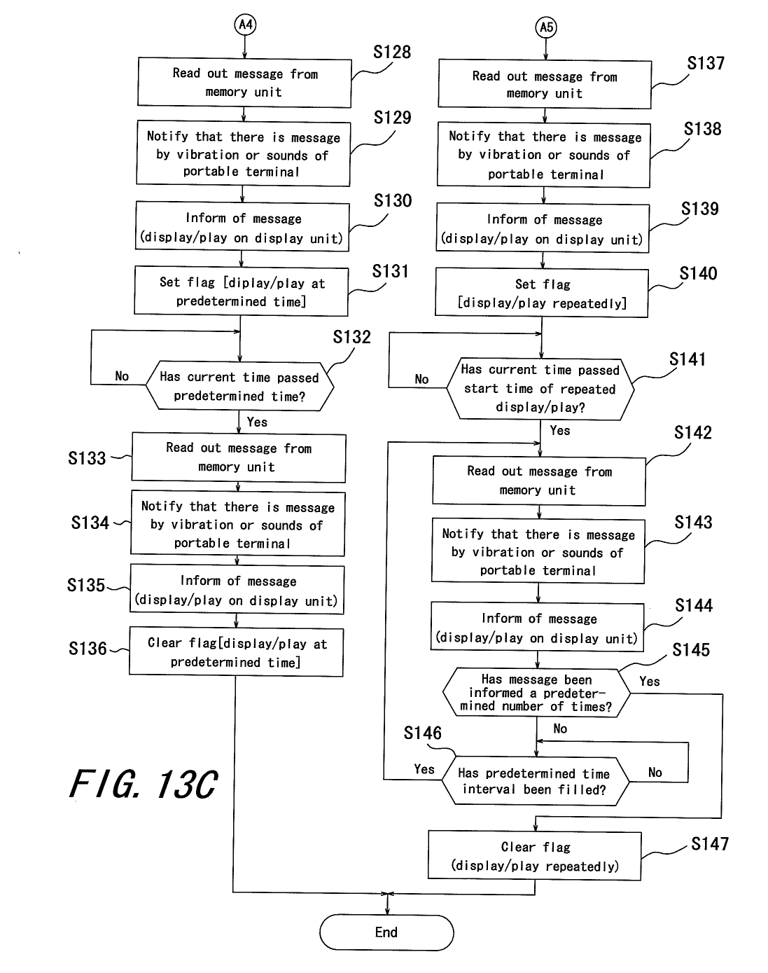

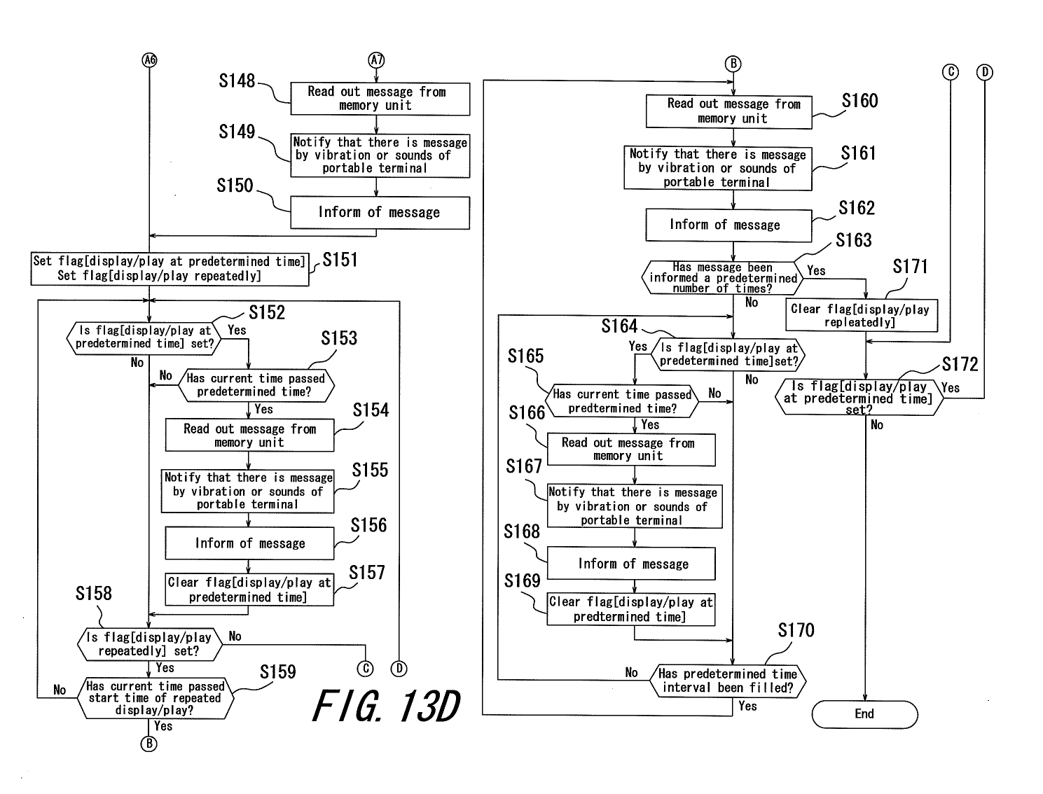

Next, the process of informing of (playing/outputting) a message in the portable terminal AT2 which has received the message from the femtocell FAP will be described by referring to drawings. FIG. 12 and FIG. 13 are flowcharts showing examples of the message informing process by the portable terminal AT2. For clarity of illustration, FIG. 12 shows a registration process between the femtocell FAP and the portable terminal AT2 and a flowchart of message transmission process by the femtocell FAP.

When receiving a message, the femtocell FAP starts a process of transmitting the message to a destination portable terminal (destination terminal) (FIG. 12, Step S41 to S48). This process is same as Step S31 to S38 in the above FIG. 10, and the description is thus omitted. The message destination terminal AT2 makes a request for registration to a femtocell FAP when the terminal enters in the service area of the femtocell FAP or the like (Step S49). The control unit 260 determines whether or not the terminal AT2 is registered in the femtocell FAP (Step S50). When the destination terminal AT2 is registered, the message is transmitted from the femtocell FAP to the terminal (Step S48). The reception unit 242 receives the message transmitted from the femtocell FAP (Step S51), and executes message playback process (Step S52). It is noted that the portable terminal AT2 makes a request for registration again after returning to Step S49 when the terminal is not registered at Step S50. However, when the registration request is refused a given number of times, the request for registration to the femtocell FAP can be terminated.

Next, there will be described a message playback process by the portable terminal AT2. FIGS. 13A to 13D are flowcharts showing examples of the message playback process. When the reception unit 242 receives a message from the femtocell FAP, the control unit 260 stores the received message in the memory unit 250 (Step S101). Next, the control unit 260 reads out timing information T-INFO included in the stored message and determines the contents (Steps S102, S103). In an example of the timing information T-INFO shown in FIG. 11, a message is played back/output in the following 7 patterns. That is, the control unit 260 controls so that a message is output “when registered (Step S104)” (or the timing information is not included in the message), “at a predetermined time (Step S105), “repeatedly (a predetermined number of times) (Step S106)”, “when registered and at a predetermined time (Step S107)”, “when registered and repeatedly (a predetermined number of times) (Step S108)”, “at a predetermined time and repeatedly (a predetermined number of times) (Step S109)” and “when registered, at a predetermined time and repeatedly (a predetermined number of times) (Step S110)”. Each pattern will be described in order.

When the timing information T-INFO indicates “output when registered” or when a message does not include the timing information T-INFO (Step S104), the control unit 260 reads out the message stored in the memory unit 250 (Step S111) and generates sounds or vibration by controlling the speaker SP or the vibration unit VI to notify of the message receipt (Step S112). Thereafter, the control unit 260 controls the display unit DIS2 to display the message received from the femtocell FAP, and informs of the message (Step S113). The method for informing of the message is not limited to the display on the display unit DIS2 by text, and the message may be informed by sounds through the speaker SP. Moreover, text of the message may be compulsorily displayed on the display unit DIS2 or may be output through the speaker SP by sounds, and an icon indicating that there is a message may be displayed.

In the case of displaying the message compulsorily on the display unit DIS2, it is preferable to display the message when there is input operation by a user (for example, operation for stopping vibration or sounds which notifies that a message is received, or the like) after it is notified that there is a message at Step S112.

When the timing information T-INFO indicates “output at a predetermined time” (Step S105), the control unit 260 reads out information about the predetermined time included in the timing information T-INFO and sets a flag showing that a message is informed (displayed/played) at the predetermined time (Step S114). The comparison unit 262 determines whether or not a current time has passed the predetermined time (Step S115). When it is determined that the current time has passed the predetermined time, the control unit 260 reads out the message from the memory unit 250 and informs of the message (Steps S116 to S118). Therefore, the message is informed at the time of reception thereof in the case that the message receipt time has passed the predetermined time or at the time when a current time has passed the predetermined time (when the current time reaches the predetermined time) in the case that the message receipt time is prior to the predetermined time. It is noted that the process of Steps S116 to S118 is same as the above Steps S111 to S113, and the description is thus omitted. The control unit 260 informs of a message at Step S118 and then clears the set flag (Step S119) to terminate the process. It is noted that as a predetermined time included in the timing information T-INFO may be set an absolute time (T:M) or a relative time (T hours/M minutes after message receipt). In this case, the comparison unit 262 compares the elapsed time after the message receipt with the predetermined time at Step S115. Thus, according to the process at Steps S114 to S119 a message sender can make it possible that a destination terminal inform of the message at a desired time (predetermined time) after the destination terminal is registered in the femtocell. Therefore, it is possible to notify a receiver of the subject of the message at a place and time at which the subject is to be fulfilled and to increase the possibility that the subject is certainly fulfilled.

When the timing information T-INFO indicates “output repeatedly (a predetermined number of times)” (Step S106), the control unit 260 reads out information about an informing start time, a time interval, a number of times which are included in the timing information T-INFO and sets a flag showing that a message is informed (displayed/played) repeatedly (Step S120). The comparison unit 262 determines whether or not a current time has passed the informing (display/play) start time (Step S121). When it is determined that the current time has passed the informing start time, the control unit 260 reads out a message from the memory unit 250 and notifies a user of the message (Steps S122 to S124). Therefore, the control unit 260 informs of a message at the time of reception thereof in the case that the message receipt time has passed the informing start time or at the time when a current time has passed the informing start time (when the current time reaches the predetermined time) in the case that the message receipt time is prior to the informing start time. Furthermore, the control unit 260 increments a count value showing a number of informing by one. It is noted that the process of Steps S122 to S124 is same as the above Steps S111 to S113, and the description is thus omitted. The control unit 262 informs of a message at Step S124 and then determines whether or not the message has been informed a predetermined number of times (Step S125). When it is determined that the message has not been informed a predetermined number of times, the comparison unit 262 determines whether or not the elapsed time after the message is informed most-recently has filled a predetermined time interval (Step S126). When it is determined that the predetermined time interval has been filled, the control unit 260 informs of a message at Steps S122 to S124 and increase a count value at every time of informing. Thereafter, the process of Steps S122 to S126 is repeated until it is determined at Step S125 that a message has been informed a predetermined number of times. When it is determined at Step S125 that a message has been informed a predetermined number of times, the control unit 260 clears the set flag (Step S127) to terminate the process. Thus, the process at Steps S120 to S127 makes it possible to inform of a message in a destination terminal a desired number of times after the terminal is registered in the femtocell. Therefore, it is possible to inform a receiver who is to fulfill the subject of the message which he is likely to forget with one-time check a plural number of times and to increase the possibility that the subject is certainly fulfilled.

When the timing information T-INFO indicates “output when registered and at a predetermined time” (Step S107), the control unit 260 reads out a message from the memory unit 250 and informs of the message (Steps S128 to S130). It is noted that the process of Steps S128 to S130 is same as the above Steps S111 to S113, and the description is thus omitted. Next, the control unit 260 reads out information about the predetermined time included in the timing information T-INFO and sets a flag showing that a message is informed (displayed/played) at the predetermined time (Step S131). Thereafter, when a current time has passed the predetermined time (achieved the predetermined time), the control unit 260 informs of the message (Steps S132 to S136). It is noted that the process of Steps S131 to S136 is same as the above Steps S114 to S119, and the description is thus omitted. The process at Steps S128 to S136 makes it possible to inform of a message in the portable terminal AT2 when registered and at the predetermined time. In the case that the femtocell is located in home, for example, it is possible to inform a receiver who is to fulfill the subject of a message, of the message when he returns home so that he can recognize that there is the subject and to notify him of the subject again at a time when the subject is to be fulfilled. Therefore, it is possible to further increase the possibility that the subject of the message is certainly fulfilled.

When the timing information T-INFO indicates “output when registered and repeatedly (a predetermined number of times)” (Step S108), the control unit 260 reads out a message from the memory unit 250 first and informs of the message (Steps S137 to S139). It is noted that the process of Steps S137 to S139 is same as the above Steps S111 to S113, and the description is thus omitted. Next, the control unit 260 reads out information about an informing start time, a time interval and a number of times which are included in the timing information T-INFO and sets a flag showing that a message is informed (displayed/played) repeatedly (Step S140). Thereafter, when a current time has passed the predetermined start time (achieved the start time), the control unit 260 informs of the message a predetermined number of times at a predetermined time intervals (Steps S140 to S147). It is noted that the process of Steps S140 to S147 is same as the above Steps S120 to S127, and the description is thus omitted. The process at Steps S137 to S147 makes it possible to inform of a message in the portable terminal AT2 when registered and a predetermined number of times. Therefore, it is possible to increase the possibility that the subject of the message is certainly fulfilled.

When the timing information T-INFO indicates “output at a predetermined time and repeatedly (a predetermined number of times)” (S109), the control unit 260 reads out information about a predetermined time, an informing start time, a time interval, a number of times which are included in the timing information T-INFO and sets a flag showing that a message is informed (displayed/played) at the predetermined time and a flag showing that the message is informed (displayed/played) repeatedly (Step S151). Next, the control unit 260 determines whether or not a flag showing that a message is informed at a predetermined time is set (Step S152), and the process goes to Step S153 when the flag is set. The comparison unit 262 determines whether or not a current time has passed the predetermined time at Step S153. When it is determined that the current time has passed the predetermined time, the control unit 260 reads out the message from the memory unit 250 and informs of the message (Steps S154 to S156). Therefore, the message is informed at the time of reception thereof in the case that the message receipt time has passed the predetermined time. The control unit 260 clears a flag showing that a message is informed at a predetermined time when the message is informed (Step S157).

In the case that a flag showing that a message is to be informed at a predetermined time is not set at Step S152, namely the case that it is determined at Step S153 that a current time has not passed the predetermined time and the case that a message is informed at Step S156, the process goes to Step S158, so that the control unit 260 determines whether or not a flag showing that a message is informed repeatedly is set. When a flag showing that a message is informed repeatedly is set, the control unit 260 informs of the message a predetermined number of times at the time when the current time has passed the informing start time (Steps S160 to S170). When the current time has passed the predetermined time during repeated informing until reaching the predetermined number of times, the control unit 260 informs of the message at the predetermined time (Steps S164 to S169). The control unit 260 clears a flag showing that a message is informed repeatedly when the message has been informed a predetermined number of times (Step S171). In the case that the informing at the predetermined time has not finished when the informing has been finished a predetermined number of times, the control unit 260 informs of a message at the predetermined time by the process of Steps S152 to S157. When the message is informed at the predetermined time and the predetermined number of times, the control unit 260 terminates the process.

When the timing information T-INFO indicates “output when registered, at a predetermined time and repeatedly (a predetermined number of times)” (Step S110), the control unit 260 informs of a message when registered (Steps S148 to S150), and processes the above Steps S151 to S172.

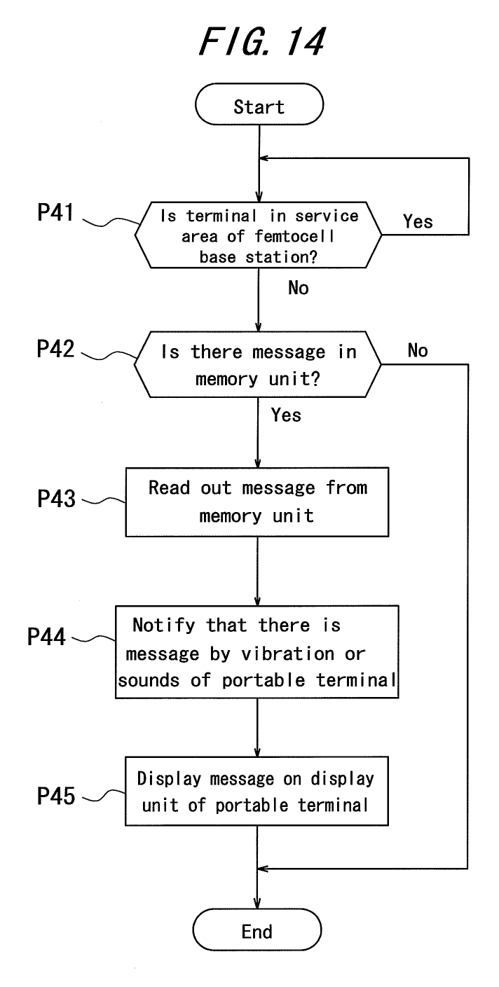

Next, there will be described an embodiment with which the possibility that the subject of a message is not fulfilled is dramatically reduced by rendering a person who is intended to fulfill the subject to become aware of the message at an adequate timing. The femtocell FAP transmits a message to a destination terminal by the process explained in FIG. 10. Then, the portable terminal AT2 receives the message from the femtocell FAP. Next, a message playback process of the portable terminal AT2 which has received a message from the femtocell FAP will be roughly described by referring to drawings. FIG. 14 is a flowchart showing an example of the message playback process of the portable terminal AT2. First, a case in which timing information T-INFO is not included in the message will be described. The control unit 260 determines whether or not a portable terminal is in the service area of the femtocell FAP (whether or not it can receive radio waves of the femtocell FAP) (Step P41). When it is determined that the terminal is out of service area (when the terminal becomes unable to detect the femtocell FAP), the control unit 260 determines whether or not a message is stored in the memory unit 250, in other words, whether or not a message is received from the femtocell FAP (Step P42). When it is determined that a message is stored in the memory unit, the control unit 260 reads out the message from the memory unit 250 (Step P43). And, the control unit 260 controls the speaker SP or the vibration unit VI to generate sounds or vibration and notifies of the message receipt (Step P44). Thereafter, the control unit 260 controls the display unit DIS2 to display the message received from the femtocell FAP, and informs of the message (Step P45). The method for informing of the message is not limited to the display on the display unit DIS2 by text, and the message may be informed by sounds through the speaker SP. Moreover, text of the message may be compulsorily displayed on the display unit DIS2 or may be output through the speaker SP by sounds, and an icon indicating that there is a message may be displayed. In the case of displaying the message compulsorily on the display unit DIS, it is preferable to display the message when there is input operation by a user (for example, operation for stopping vibration or sounds which notifies that a message is received, or the like) after it is notified that there is a message at Step P44. In addition, since the message is notified (informed) because it is determined that a terminal is out of service area, it is preferable not to notify (inform) of the message when the message is received in service area.

In this way, in this embodiment, when the portable terminal AT2 is out of service area of the femtocell FAP (when the terminal becomes unable to detect the femtocell FAP), a message is informed in the portable terminal AT2. That is, a message can be informed when a user of the portable terminal AT2 is out of service area of the femtocell FAP, in other words, just at the time when the user goes out from home or an office. Therefore, it is possible to remind the message receiver of a thing left behind or a thing asked to do when he can immediately return home or to the office.

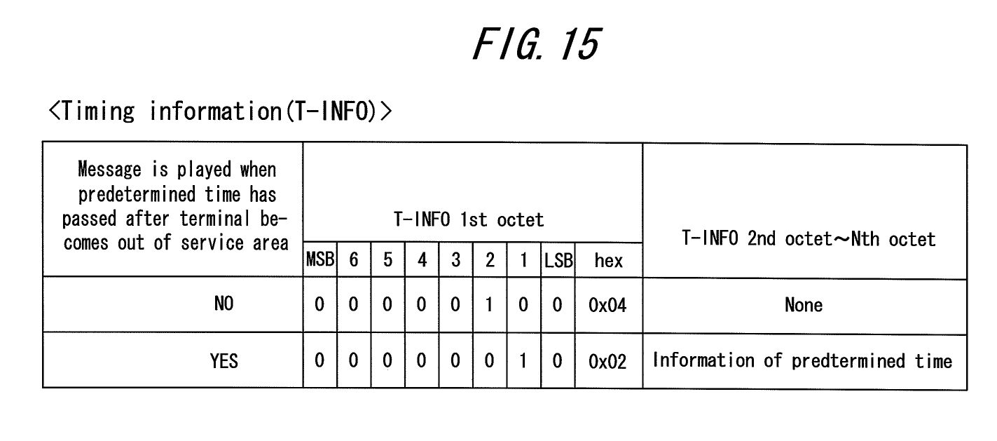

Next, an embodiment in which a message is informed when a predetermined time has passed after a destination terminal becomes out of service area (after the terminal becomes unable to detect the femtocell FAP) will be explained. A message is informed at the time when the destination terminal is out of service area in the above embodiment, while it is conceivable that, depending on the contents of a message, a sender wants to inform an addressee of the message when a predetermined time has passed after the destination terminal becomes out of service area (after an addressee goes out), for example, in a case in which a sender requests the addressee to do a thing while the addressee is outside, or the like. In this case, the timing information T-INFO may be included in the message MSG1 (or MSG2) transmitted to the portable terminal AT from the femtocell FAP. The timing information T-INFO will be described here. FIG. 15 shows an example of the timing information T-INFO. As shown, the timing information T-INFO includes information indicating when a message which the portable terminal AT has received is informed (played/displayed) after the portable terminal AT becomes out of service area of the femtocell FAP. In the example of the drawing, the timing information T-INFO includes information indicating “whether or not a message is played or not when a predetermined time has passed after a destination terminal becomes out of service area” in the first octet. In addition, the second octet includes information required to conduct the process ordered in the first octet. For example, when the timing information T-INFO (second line) indicates “play when a predetermined time has passed after the destination terminal becomes out of service area”, the second octet includes information about the “predetermined time”.

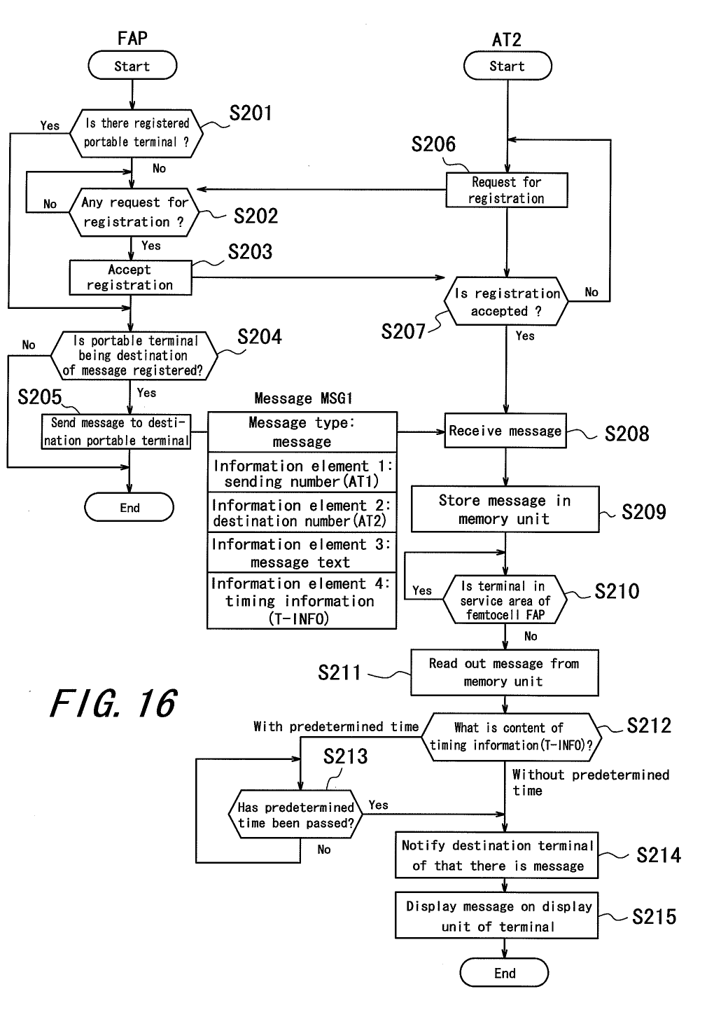

Next, a message playback process of the portable terminal AT2 which has received a message (including the timing information T-INFO) from the femtocell FAP will be described by referring to drawings. FIG. 16 is a flowchart showing an example of the message playback process by the portable terminal AT2. For clarity of illustration, FIG. 16 shows a registration process between the femtocell FAP and the portable terminal AT2 and a flowchart of message transmission process by the femtocell FAP.

When receiving a message from a message sending terminal, the femtocell FAP starts a process of transmitting the message to a destination portable terminal (destination terminal) (FIG. 16, Steps S201 to S205). This process is substantially same as in the above FIG. 10, and the description is thus omitted. The message destination terminal AT2 makes a request for registration to a femtocell FAP when the terminal enters in the service area of the femtocell FAP or the like (Step S206). The control unit 260 determines whether or not the terminal AT2 is registered in the femtocell FAP (Step S207). When the destination terminal AT2 is registered, the message is transmitted from the femtocell FAP to the terminal (Step S205), and the reception unit 242 receives the message transmitted from the femtocell FAP (Step S208). It is noted that the portable terminal AT2 makes a request for registration again after returning to Step S206 when the terminal is not registered at Step S207, and that when the registration request is refused a given number of times, the request for registration to the femtocell FAP can be terminated.

The portable terminal AT2 stores a received message in the memory unit 250 (Step S209). Next, the control unit 260 determines whether or not the portable terminal is in the service area of the femtocell FAP (whether or not it can receive radio waves of the femtocell FAP) (Step S210). When it is determined that it is not in a service area, the control unit 260 reads out the message from the memory unit 250 (Step S211) and determines the contents of the timing information T-INFO (Step S212). When the timing information T-INFO indicates “play when a predetermined time has passed”, the process goes to the Step S213. Then, the comparison unit 262 determines whether or not the elapsed time after the terminal becomes out of service area has filled the predetermined time shown by the timing information T-INFO (Step S213). When it is determined at Step S213 that the elapsed time after the terminal becomes out of service area has passed the predetermined time (achieved the predetermined time) or when the timing information T-INFO indicates “not specifying a predetermined time” at Step S212, the process goes to Step S214, and the control unit 260 generates sounds or vibration by controlling the speaker SP or the vibration unit VI to notify of the message receipt (Step S214). And then, the control unit 260 controls the display unit DIS2 to display the message received from the femtocell FAP, and informs of the message (Step S215). In addition, since the message is notified (informed) because it is determined that a terminal is out of service area, it is preferable not to notify (inform) of the message when the message is received in service area.

Thus, a message sender can inform a destination terminal of a message at a desired time (predetermined time) after the destination terminal becomes out of service area of the femtocell, by transmitting a message including information specifying a time when the message is to be informed to the portable terminal. Therefore, it is possible to increase the possibility that a subject is fulfilled since a message is certainly notified to a receiver when the receiver is not at home, unlike the conventional art with which a message may be checked when a receiver is not outside although a request is intended to be fulfilled outside. It is noted that a time specified by the timing information T-INFO can be set not to an elapsed time (i.e., relative time) after a terminal becomes out of service area but to a specified time (e.g., T:M or the like). When the time of message receipt has passed the specified time, the control may be performed so that the informing is made at the time of message receipt. In this invention, the femtocell transmits a message at the time when a portable terminal enters in the service area of the femtocell (e.g., when registered), so that the message is retained in the portable terminal which a user always carries. Therefore, the message to be notified is stored when the terminal is out of service area of the femtocell, which makes it possible to certainly notify the receiver of the message.

The advantages of the invention will be described again. The invention makes it possible to provide techniques for informing of messages in houses of general household or small offices with use of a mobile station (portable terminal device) and the femtocell (a base station and a mobile station serving as message processing apparatuses). Therefore, a user having a mobile station can be informed of a message at adequate time and place, which can dramatically decrease the possibility that the subject of a message is not fulfilled. Moreover, it is possible to transmit a message with specifying a time (timing) and the number of times that the message is to be informed to a mobile station, which can dramatically decrease the possibility that a message receiver forgets to fulfill the subject.

Although the invention has been described above with reference to several drawings and examples, it is noted that those skilled in the art will easily make various modifications based on the invention. Therefore, it is noted that these modifications are included within the scope of the invention. For example, functions performed in each member, means, step or the like can be rearranged so as not to be logically inconsistent, and it is possible to combine a plurality of means, steps or the like into one or to divide the same. For example, the embodiment in which a message is informed based on the timing information T-INFO has been described. However, the invention is not limited thereto. That is, it is possible to inform of a message at the time of message receipt from the femtocell without referring to the timing information T-INFO. In the above example, moreover, the femtocell allows only terminals having permission for use of the femtocell, registration, and transmits the message thereto. However, the invention is not limited thereto. All terminals having made a request for registration to the femtocell can be registered, and the message can be sent. Moreover, the above out of service area of the femtocell also includes a state in which radio waves of the femtocell cannot be received, a state in which there occurs the handover from the femtocell to another base station, or the like.

What is claimed is:

1. A base station of a mobile communication system comprising,
a memory unit storing a message whose destination is a mobile station of the mobile communication system; and
a transmission unit transmitting the message to a mobile station which is the destination of the message stored in the memory unit when the mobile station has been registered or got registered in the base station.

2. The base station according to claim 1, wherein the message includes timing information indicating timing when the mobile station informs of the message.

3. The base station according to claim 1, wherein the message includes timing information indicating timing when the message is to be informed after the mobile station has become unable to detect the base station.

4. The base station according to claim 1, further comprising;
a registration unit registering information of a mobile station using the base station, and the memory unit stores a message whose destination is a mobile station registered in the registration unit.

5. The base station according to claim 1, further comprising;
a reception unit receiving the message from a mobile station registered in the base station,
wherein the memory unit stores the message received by the reception unit.

6. The base station according to claim 1, further comprising;
an input unit accepting input operation into the base station; and
a generation unit generating a message whose destination is a mobile station of the mobile communication system based on input to the input unit,
wherein the memory unit stores the message generated by the generation unit.

7. A mobile station comprising,
a reception unit receiving a message whose destination is the mobile station itself stored in a base station from the base station of a mobile communication system;
a memory unit storing the message received by the reception unit; and
a control unit controlling so that the message received from the base station and stored in the memory unit is informed when it becomes impossible to detect the base station from which the message has been received.

8. The mobile station according to claim 7, wherein the message includes timing information indicating timing when the message is to be informed by the mobile station after the mobile station has become unable to detect the base station, and the control unit controls so that the message is informed based on the timing information.

9. A mobile station comprising,
a reception unit receiving a message whose destination is the mobile station itself stored in a base station from the base station of a mobile communication system;
a memory unit storing the message received by the reception unit; and
a control unit controlling so that the message is informed based on timing information indicating timing when the message is informed which is included in the message stored in the memory unit.

10. The mobile station according to claim 9, wherein the control unit controls so that the message received by the reception unit is informed in the case that timing when the message is received by the reception unit has passed timing when the message is supposed to be informed based on the timing information.
